(19) United States
(12) Patent Application Publication
(10) Pub. No.: US 2008/0190493 A1
(43) Pub. Date: Aug. 14, 2008

(54) SENSOR MODULE, FLUID CIRCULATION SYSTEM HAVING THE SAME, AND METHOD FOR ASSEMBLING SENSOR MODULE

(76) Inventors: Chang-Hoon OH, Gyeonggi-Do (KR); Si-Hong Ahn, Seoul (KR); Ki-Chang Song, Gyeonggi-Do (KR)

Correspondence Address: BIRCH STEWART KOLASCH & BIRCH, PO BOX 747, FALLS CHURCH, VA, 22040-0747, US

(21) Appl. No.: 12/030,717

(22) Filed: Feb. 13, 2008

(30) Foreign Application Priority Data
Feb. 14, 2007 (KR) 10-2007-0015580
Feb. 14, 2007 (KR) 10-2007-0015581

(51) Int. Cl. F16K 37/00; B21D 39/00

(52) U.S. Cl. 137/554; 29/428

(57) ABSTRACT

Disclosed is the sensor module, including a housing having a connection path connected to a channel on which a fluid flows; a sensor disposed inside the housing so as to be communicated with the connection path, and measuring information about the fluid introduced from the connection path; and an overpressure protection means disposed at the connection path, and selectively blocking the connection path according to a pressure applied from the fluid so as to prevent the transfer of a pressure greater than a reference pressure to the sensor, the circulation system having the same, and the method for assembling the sensor module. It can prevent the transfer of an excessive pressure of the fluid to the sensor, thereby preventing the sensor from being damaged by the overpressure.

### BACKGROUND OF THE INVENTION

1. Field of the Invention

The present invention relates to a sensor module which detects physical property or chemical property of a fluid, a fluid circulation system having the same, and a method for assembling the sensor module.

2. Description of the Background Art

An air conditioner, such as a cooler, a heater or an air cleaner, is provided with a sensor which detects information about a refrigerant including pressure or temperature of a refrigerant. Based on the information about the refrigerant detected by the sensor, a refrigerant circulation of the air conditioner is controlled. In order to detect the information about the refrigerant, the sensor needs to be communicated with a pipeline in which the refrigerant flows.

However, the refrigerant flowing in the pipeline is driven by a driving source (e.g., a compressor), thereby causing pulsation. Due to such pulsation, excessive pressure is transferred to the sensor, damaging the sensor. In particular, when a compressor malfunctions or a refrigerant circulation system does not work properly, excessive pressure of the refrigerant may damage the sensor.

### SUMMARY OF THE INVENTION

It is an object of the present invention to prevent the damage of a sensor due to an overpressure, by preventing the transfer of an excessive pressure of a fluid to the sensor.

To achieve these and other advantages and in accordance with the purpose of the present invention, as embodied and broadly described herein, there is provided a sensor module, including: a housing having a connection path connected to a channel on which a fluid flows; a sensor disposed inside the housing so as to be communicated with the connection path, and measuring information about the fluid introduced from the connection path; and an overpressure protection means disposed at the connection path, and selectively blocking the connection path according to a pressure applied from the fluid so as to prevent the transfer of a pressure greater than a reference pressure to the sensor.

The overpressure protection means includes a fixed portion fixed to the connection path; a blocking portion selectively blocking the connection path by movement; and an elastic portion connecting the fixed portion and the blocking portion, and elastically deformed according to an intensity of the pressure transferred to the blocking portion so as to enable the blocking portion to selectively block the connection path.

A hollow portion is formed in the fixed portion so as to flow the fluid therein, and the blocking portion is disposed on the hollow portion and is formed in a shape corresponding to the connection path.

The sensor module is further provided with an interface board electrically connected to the sensor, and having an interface circuit for processing an electrical signal outputted from the sensor patterned thereon.

The sensor module is further provided with an output terminal unit electrically connected to the interface board, and outputting an electrical signal transmitted from the interface board to the outside.

There is provided a sensor module, including: a sensor for detecting information about a fluid flowing along a channel; a connection path for communicating the channel with the sensor so as to introduce the fluid flowing along the channel into the sensor; and an overpressure protection member for selectively blocking the connection path according to an intensity of a pressure applied from the fluid so as to prevent the transfer of a pressure greater than a reference pressure to the sensor.

There is provided a fluid circulation system, including: a driving source; a channel on which a fluid driven by the driving source flows; and a sensor module connected to the channel so as to detect information about the fluid, wherein the sensor module comprises: a housing having a connection path communicated with the channel on which the fluid flows; a sensor disposed inside the housing so as to measure information about the fluid introduced via the connection path; and an overpressure protection member for selectively blocking the connection path according to a pressure applied from the fluid so as to prevent the transfer of a pressure greater than a reference pressure to the sensor.

The fluid circulation system is further comprised of a microcomputer for controlling the driving source based on the information about the fluid detected by the sensor module; wherein the sensor module comprises: a sensor for detecting the fluid information and outputting the detected information as a primary electrical signal; and an interface circuit for converting the primary electrical signal into a secondary electrical signal so as to correspond to a reference profile stored in the microcomputer.

There is provided a fluid circulation system, including: a channel on which a fluid is circulated; a sensor disposed on the channel to detect fluid information; a connection path for connecting the channel and the sensor so as to flow the fluid therebetween; and an overpressure protection member for selectively blocking the connection path according to a pressure applied from the fluid so as to prevent the transfer of a pressure greater than a reference pressure of the fluid to the sensor.

There is provided a method for assembling a sensor module, including: mounting an overpressure protection member for selectively blocking a connection path according to a pressure applied from a channel, to a nozzle portion having the connection path connected to the channel so as to be communicated therewith; installing, to the nozzle portion, a sensor for detecting fluid information; mounting, to the sensor, an interface board for processing an electrical signal outputted from the sensor; installing, on the interface board, an output terminal unit for transferring the electrical signal to the outside; and coupling, to the nozzle portion, a cover for hermetically covering the sensor and the interface board from the outside.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view showing a sensor module according to one embodiment of the present invention;

FIG. 2 is an exploded perspective view showing the sensor module shown in FIG. 1;

FIG. 3 is a cross-sectional view showing the sensor module taken along line III-III in FIG. 1;

FIG. 4 is a detail diagram showing the part “A” in FIG. 3;

FIG. 5 is a perspective view showing the overpressure protection member shown in FIG. 2;

FIGS. 6a and 6b are cross-sectional views respectively showing the sensor module to explain an operational state of the sensor module;

FIG. 7 is a circuit diagram showing an interface circuit patterned on the interface board shown in FIG. 2;

FIG. 8 is a graph showing a process that a profile of an electrical signal of information about a fluid is converted by the interface circuit shown in FIG. 7;

FIGS. 9a through 9e are perspective views showing the sensor module to explain an assembly process of the sensor module shown in FIG. 1;

FIG. 10 is a perspective view showing an overpressure protection means according to another embodiment of the present invention;

FIG. 11 is a cross-sectional view showing the sensor module according to another embodiment of the present invention; and

FIG. 12 is a conceptual view showing an air conditioner as an exemplary fluid circulation system to which the sensor module according to the present invention is applied.

### DETAILED DESCRIPTION OF THE INVENTION

Hereinafter, exemplary embodiments according to the present invention will be explained in more detail with reference to the accompanying drawings.

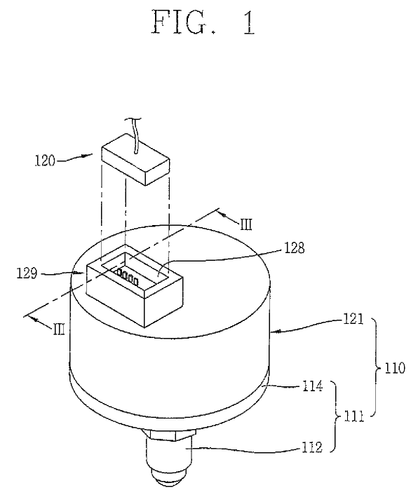

FIG. 1 is a perspective view showing a sensor module according to one embodiment of the present invention.

The sensor module according to one embodiment of the present invention is to detect information about a fluid flowing along a channel, and a housing 110 forming an outer aspect of the sensor module may include a nozzle unit 111, and a cover 121 coupled to the nozzle unit 111.

The housing 110 is constructed to be hermetically covered so as to protect components mounted therein from external factors such as moisture. The nozzle unit 111 and the cover 121 are coupled to each other with a sealed state.

The nozzle unit 111 is configured to be coupled to the channel so as to introduce the fluid flowing on the channel into the sensor module. And, a connector unit 129 is disposed in the cover 121 so as to couple the sensor module to an external device.

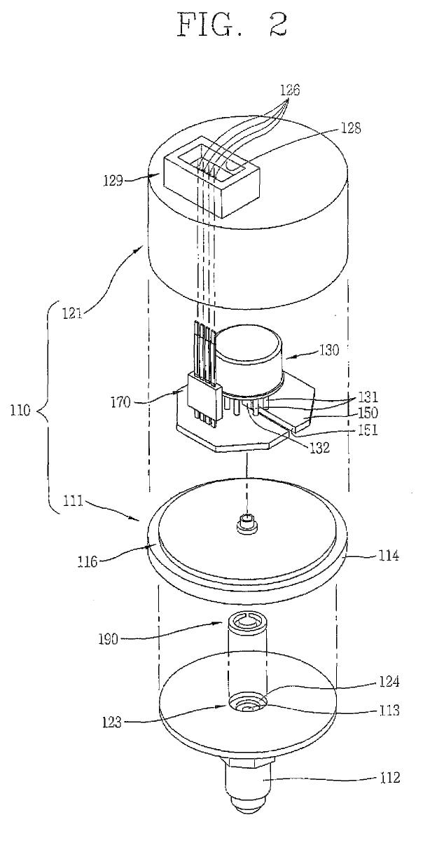

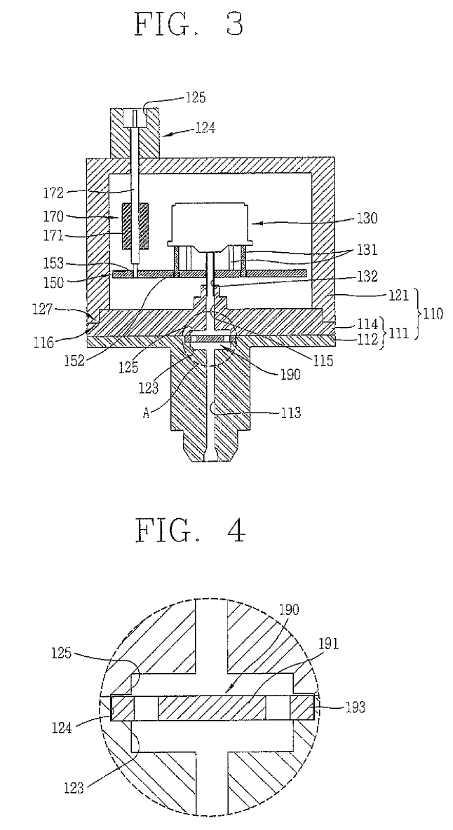

FIG. 2 is an exploded perspective view showing the sensor module shown in FIG. 1, and FIG. 3 is a cross-sectional view showing the sensor module taken along line III-III in FIG. 1.

A sensor 130, an interface board 150, an output terminal unit 170 and an overpressure protection member 190 are disposed in a space formed between the nozzle unit 111 and the cover 121.

Connection paths 113, 115 are respectively formed in the nozzle unit 111 so as to communicate the channel on which the fluid flows with the inside of the housing 110. The fluid on the channel is introduced into the sensor 130 disposed inside the housing 110 via the connection paths 113, 115.

The nozzle unit 111 may include a first nozzle portion 112 coupled to the s channel, and a second nozzle portion 114 fixed to the first nozzle portion 112. The first and second connection paths 113, 115 communicated with the channel and for guiding the fluid on the channel to the sensor 130 are respectively formed in the first and second nozzle portions 112, 114.

The first nozzle portion 112 can be connected to the channel by welding or thread coupling such that the first connection path 113 can be communicated with the channel, and the second nozzle portion 114 can be fixed to the first nozzle portion 112 by a fixing means such as an adhesive.

A first mounting portion 123 and a second mounting portion 125 for mounting the overpressure protection means 190 thereon are respectively formed at the first and second nozzle portions 112, 114.

The first mounting portion 123 is formed to extend the first connection path 113 in an upper central portion of the first nozzle portion 112, that is, on a surface facing the second nozzle portion 114. The second mounting portion 125 is formed to extend the second connection path 115 on a surface facing the first nozzle portion 112 of the second nozzle portion 114.

A fixing hole 124 concavely formed in a radial direction of the first mounting portion 123 is disposed in the first mounting portion 123. The fixing hole 124 serves as a hole to fix the overpressure protection means 190 therein, and an installation structure of the overpressure protection means 190 will be described later.

The cover 121 is formed to have a cylindrical shape having a lower side thereof open. A lower end of the cover 121 is coupled to the second nozzle portion 114 so as to be in a sealed state.

A nozzle stepped portion 116 is formed along the circumference of the second nozzle portion 114. And, a cover stepped portion 127 is formed at a lower end of the cover 121 so as to correspond to the nozzle stepped portion 116. The nozzle stepped portion 116 and the cover stepped portion 127 are in a sealed state, thus to prevent the sensor 130 from being damaged by moisture from the outside.

A connector receiving groove 128 for receiving a connector 120 of an external device therein is formed at the connector unit 129 disposed at an upper side of the cover 121. A plurality of exposing holes 126 are formed at a lower surface of the connector receiving groove 128 so that an end portion of the output terminal unit 170 can be exposed outside by being inserted therethrough.

A sealing means such as an adhesive may be deposited between the exposing hole 126 and the output terminal unit 170 such that the inside and outside of the housing 110 can be in a sealed state.

The sensor 130 is configured to detect information about a fluid introduced via the first and second connection paths 113, 115, and to output the detected information as electrical signals. In particular, the sensor 130 detects a pressure and temperature of a fluid.

A third connection path 132 into which the fluid is introduced is formed at the sensor 130, and is coupled to the second connection path 115 so as to be communicated therewith. The third connection path 132 may be fixed to the second connection path 115 by a brazing means after being inserted into the inside of the second connection path 115.

A plurality of sensor output pins 131 are provided in the sensor 130 to transmit electrical signals of fluid information to the outside. The sensor output pins 131 are extended toward the interface board 150 so as to be electrically connected thereto.

The interface board 150 is disposed between the second nozzle portion 114 and the sensor 130. An interface circuit is patterned on the interface board 150 to process the electrical signals of the fluid information transmitted from the sensor 130.

On the interface board 150, there are provided a plurality of sensor connection holes 152 for electrically connecting the sensor output pin 131 to the interface circuit, and a plurality of terminal connection holes 153 for electrically connecting the output terminal unit 170 to the interface circuit.

The sensor output pins 131 and the end portion of the output terminal unit 170 may be fixed by soldering, etc. after being respectively inserted into the sensor connection holes 152 and the terminal connection holes 153.

On the interface board 150 is formed a slit 151 for inserting the third connection path 132 therein so as to couple the interface board 150 to the sensor 130 in a state that the sensor 130 and the second nozzle portion 114 are connected. The slit 151 may be formed to open from a nearly central portion of the interface board 150 to an end portion of the interface board 150.

The output terminal unit 170 may include a plurality of output lines 172, and a guide member 171 for fixing the plurality of output lines 172.

One end of the output line 172 is inserted into the terminal connection hole 153 of the interface board 150, and another end of the output line 172 is exposed outside through the connector unit 129. The output line 172 is coated by a plastic material, etc., however, both ends of each output line 172 should not be coated since they are electrically connected to the interface circuit and the connector 120, respectively.

The guide member 171 serves to fix the plurality of output lines 172 as one unit, and to maintain the distance between the plurality of output lines 172 at a certain interval. Accordingly, both ends of the output line 172 may be easily inserted into the terminal connection hole 153 of the interface board 150 and the exposing hole 126 of the connector unit 129.

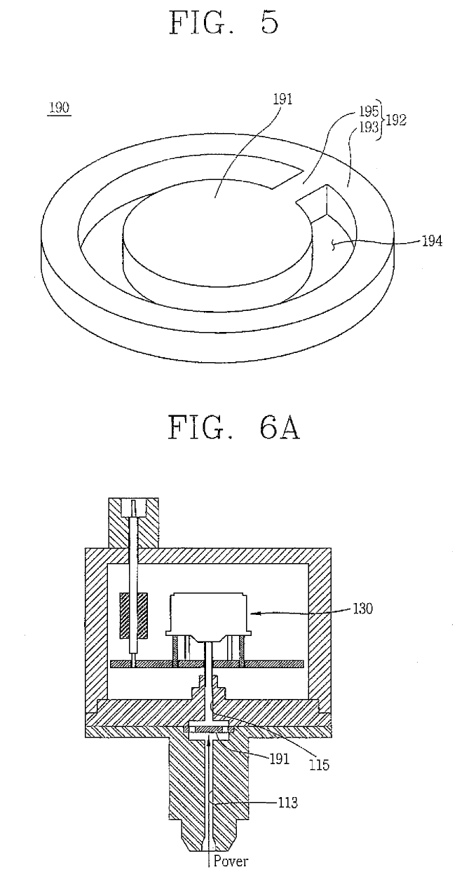

The overpressure protection member 190 is to prevent the transfer of excessive pressure greater than a reference pressure to the sensor 130, and will be described in detail with reference to FIGS. 4 and 5. FIG. 4 is a detail diagram showing the part “A” in FIG. 3, and FIG. 5 is a perspective view showing the overpressure protection member shown in FIG. 2.

The overpressure protection member 190 includes a blocking portion 191, and a support portion 192 disposed at a periphery thereof.

The blocking portion 191 is to selectively block the second connection path 115, and may be formed in a shape corresponding to the second connection path 115. In addition, the blocking portion 191 may have a radius greater than the second connection path 115, and be formed as a thin film of an elastic material (e.g., rubber materials) to effectively block the second connection path 115.

The support portion 192 is to elastically support the blocking portion 191, and may include a ring-type fixed portion 193 having a hollow portion 194 therein and an elastic portion 195 for connecting the blocking portion 191 to the fixed portion 193.

The blocking portion 191 is disposed on the hollow portion 194 in the fixed portion 193, and the overpressure protection member 190 is configured so that fluid can flow through the hollow portion 194. The fixed portion 193, being inserted into the fixing hole 124, is fixed to the first nozzle portion 112 by bonding the first nozzle portion 112 and the second nozzle portion 114.

The elastic portion 195 is configured to be connected to the fixed portion 193 by extending from one side of the blocking portion 191 to elastically support the blocking portion 191. When an excessive pressure greater than the reference pressure is applied to the blocking portion 191, the elastic portion 195 is elastically deformed and thus to move the blocking portion 191 in a direction where the pressure is applied. Accordingly, the blocking portion 191 blocks the second connection path 115.

A movement distance of the blocking portion 191 according to a pressure applied to the blocking portion 191 depends on a spring constant and length of the elastic portion 195. Accordingly, depending on the allowable pressure (reference pressure) of the sensor 130, a length, material or cross-section of the elastic portion 195 may be adjusted.

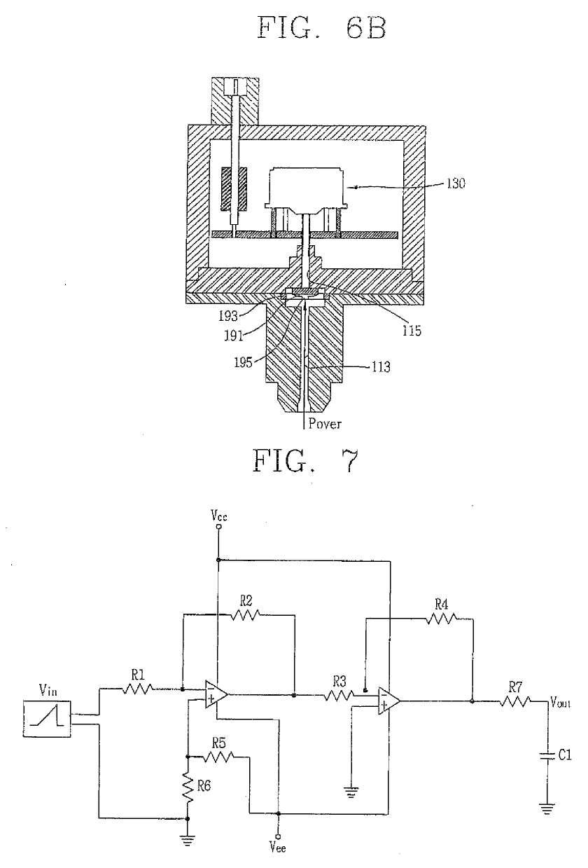

Hereinafter, an operational state of the sensor module with such configuration will be described in detail. FIGS. 6a and 6b are cross-sectional views respectively showing the sensor module to explain an operational state of the sensor module.

Referring to FIG. 6A, the fluid flowing on the channel passes the first connection path 113, and then passes the hollow portion 194 of the overpressure protection member. Then, the fluid having passed the hollow portion 194 is introduced to the sensor 130 along the second and third connection paths 115, 132.

During these steps, when a problem occurs in the fluid circulation system or a driving source (e.g., a compressor) malfunctions, and if a pressure (Pₒᵥₑᵣ) greater than the reference pressure is generated, such pressure is transferred to the blocking portion 191 of the overpressure protection member 190 via the first connection path 113.

Referring to FIG. 6B, the pressure transferred to the blocking portion 191 is transferred to the elastic portion 195 as a force elastically deforming the elastic portion 195. As the elastic portion 195 is deformed, the blocking portion 191 moves toward the second connection path 115, thereby blocking the second connection path 115.

On the contrary, when the overpressure (Pₒᵥₑᵣ) is released, the elastic portion 195 is returned to its original state by a restoration force, as shown in FIG. 6A. However, if the overpressure (Pₒᵥₑᵣ) is not released, as shown in FIG. 6B, the second connection path 115 is always maintained in a blocked state.

As the blocking portion 191 is moved by elastic deformation of the elastic portion 195, the overpressure can be prevented from being continuously transferred to the sensor 130. In addition, the blocking portion 191 can prevent the transfer of temporary overpressure to the sensor 130, and when the temporary overpressure is released, the sensor 130 can measure fluid information.

When the fluid is introduced to the sensor 130, the sensor 130 converts fluid information into an electrical signal, and applies the converted signal to the interface board 150 via the sensor output pins 131.

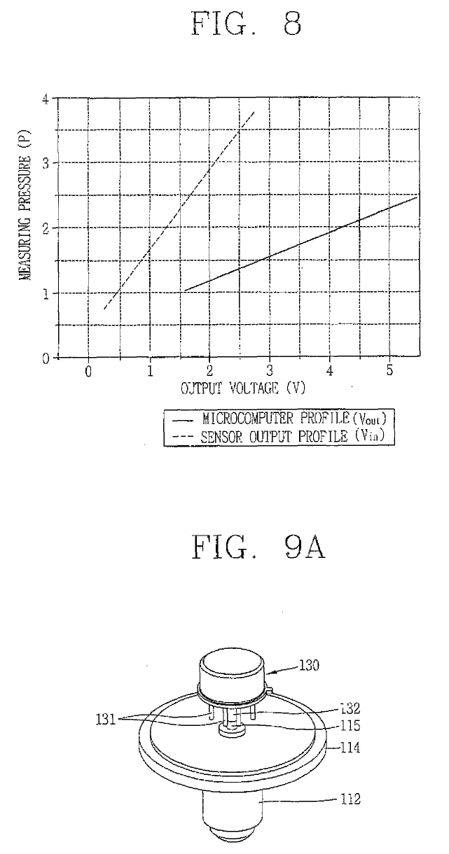

FIG. 7 is a circuit diagram showing an interface circuit patterned on an interface board shown in FIG. 2, and FIG. 8 is a graph showing a process that a profile of an electrical signal of fluid information is converted by the interface circuit shown in FIG. 7.

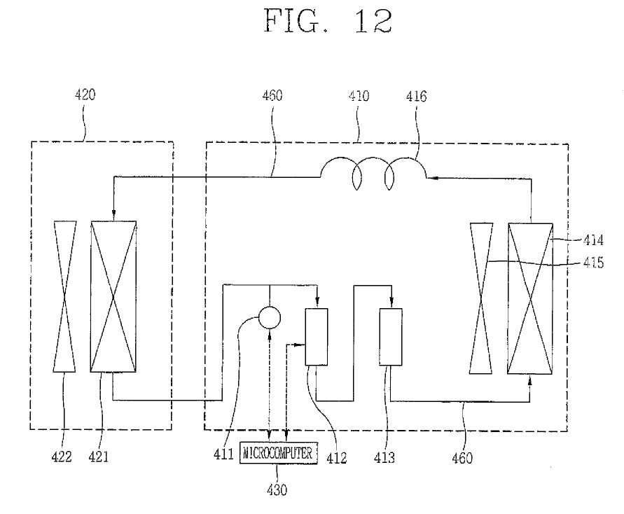

Referring to FIG. 7, the interface circuit patterned on the interface board 150 is configured to convert a primary electrical signal outputted from the sensor 130 into a secondary electrical signal, and the secondary electrical signal is transmitted to an external device (e.g., microcomputer 430, referring to FIG. 12) through the output line.

The interface circuit is configured to convert the primary electrical signal outputted from the sensor 130 into the secondary electrical signal, which corresponds to a reference profile of the microcomputer 430.

If the electrical signal is assumed as a voltage, as shown in FIG. 8, Vᵢₙ indicates an output voltage corresponding to the pressure or temperature of the fluid from the sensor 130, and Vₒᵤₜ indicates a voltage of the reference profile stored in a storage unit of the microcomputer 430. The interface circuit as shown in FIG. 7 may have a relation of the following mathematical formula 1 with respect to the input voltage Vᵢₙ and the output voltage Vₒᵤₜ.

Vₒᵤₜ=A×Vᵢₙ+B [Formula 1]

wherein, it is defined for A=(R2×R4)/(R1×R3), and B=(1+R2/R1)×R6/(R5+R6)×Vₑₑ

A indicates a gain, and B indicates an offset voltage.

According to the mathematical formula 1, the sensor output profile (shown by a dotted line in FIG. 8) with respect to the voltage (Vᵢₙ) outputted from the sensor 130 and the fluid information {measured pressure (P)} is converted into the reference profile stored in the microcomputer 430 (shown by a solid line in FIG. 8). Accordingly, as shown in the mathematical formula 1, the electrical signal outputted from the sensor 130 may be variably controlled by adjusting an interference value and Vₑₑ formed in the interface circuit.

Accordingly, by the interface circuit, the sensor 130 can be respectively applied to various microcomputers 430 in which different reference profiles are stored. That is, the interface circuit can enable a particular type of sensor to be commonly applied to various systems.

The interface circuit shown in FIG. 7 describes an exemplary circuit which can convert the primary electrical signal outputted from the sensor 130 into the secondary electrical signal of the reference profile. In addition to this, various types of interface circuits capable of converting a primary electrical signal into a secondary electrical signal having a gain and offset value may be applied onto the interface board 150.

Hereinafter, the description of a method for assembling the sensor module will be given in detail.

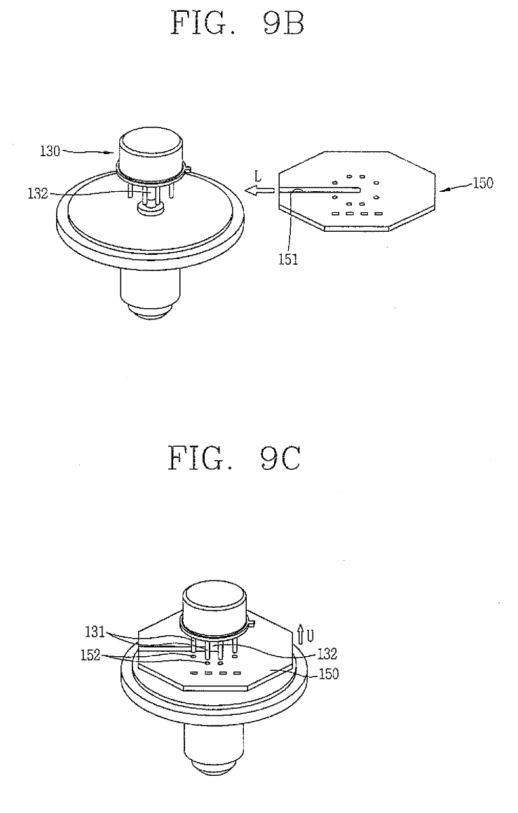

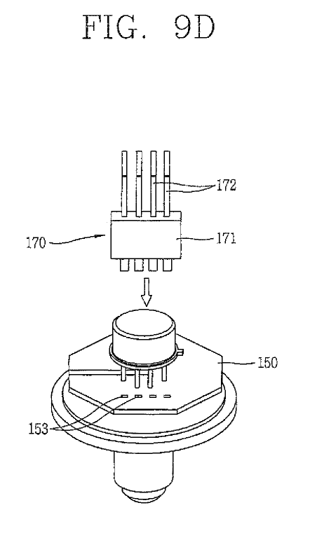

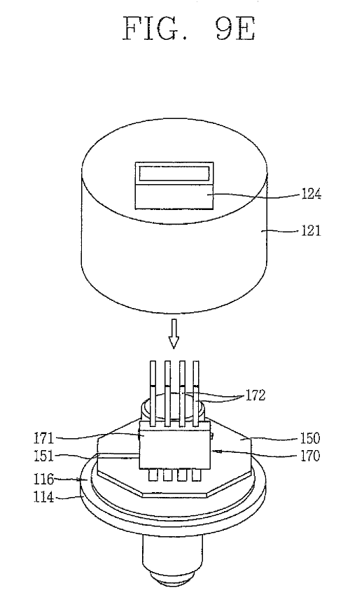

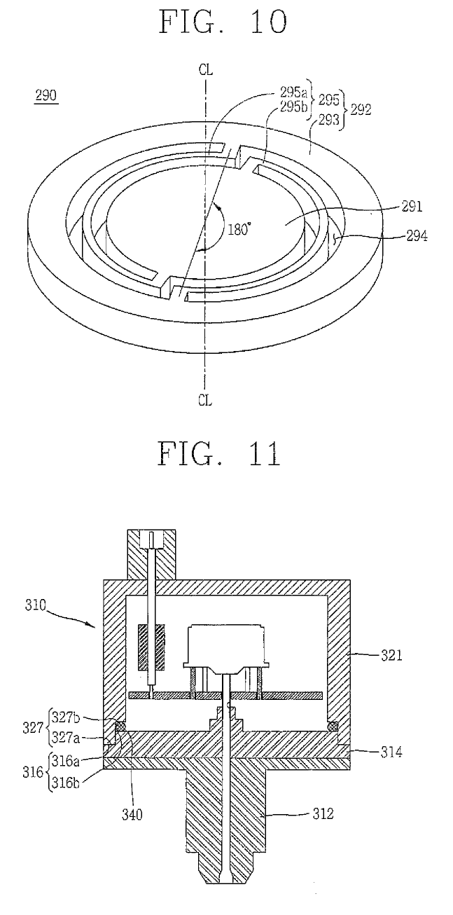

FIGS. 9A through 9e are perspective views respectively showing an assembly process of the sensor module shown in FIG. 1.

Referring to FIG. 9A, the fixed portion 193 of the overpressure protection means 190 is disposed in the fixing hole 124 of the first nozzle portion 112, and then the first nozzle portion 112 and the second nozzle portion 114 are coupled by adhesive, and the like. Here, the third connection path 132 of the sensor 130 is inserted into the second connection path 115 of the second nozzle portion 114, and then the second connection path 115 and the third connection path 132 are coupled by the coupling means such as a brazing means, thus to fix the sensor 130 to the second nozzle portion 114. Here, the sensor 130 should be spaced from an upper surface of the second nozzle portion 114 with a certain distance therebetween, and the sensor output pins 131 should be spaced from the upper surface of the second nozzle portion 114 with a certain distance therebetween.

Referring to FIG. 9B, the slit 151 of the interface board 150 is moved in a direction perpendicular to a lengthwise direction of the third connection path 132 such that the third connection path 132 of the sensor 130 can be inserted thereinto. Then, the interface board 150 is moved until the third connection path 132 is positioned at the center of the interface board 150.

Referring to FIG. 9C, when the third connection path 132 is positioned at the center of the interface board 150, the interface board 150 is then moved in a lengthwise direction of the third connection path 132, thus to insert the sensor output pins 131 into the respective sensor connection holes 152. The sensor output pins 131 are fixed to the respective sensor connection holes 152 by soldering, and the like.

Referring to FIG. 9D, one end of the output terminal unit 170, that is, one end of each output line 172 is inserted into the respective terminal connection holes 153, and then the output lines 172 are fixed to the interface board 150 by soldering, and the like. Here, the guide member 171 can easily undergo a soldering process by being grasped, thus to facilitate the soldering process. Further, the output lines 172 are spaced from each other with a certain distance therebetween, thus to fix the output lines 172 onto the interface board 150 more precisely and easily.

Referring to FIG. 9E, in a state that the output terminal unit 170 is fixed onto the interface board 150, the cover 121 is coupled to the second nozzle portion 114. Here, another end of each output line 172 is inserted into the respective exposing holes 126 (referring to FIG. 2) formed on the connector unit 129 of the cover 121, and the cover stepped portion 127 (referring to FIG. 3) is mounted to the nozzle stepped portion 116. The end of each output line 172 is fixed to each protruding hole 126 (referring to FIG. 2) by a fixing means such as an adhesive while the inside of the housing 110 is in a sealed state. In addition, the cover stepped portion 127 (referring to FIG. 3) is bonded to the nozzle stepped portion 116 in a sealed state by a bonding means such as a pre-deposited adhesive.

With such processes, the housing 110, the sensor 130, the interface board 150, the output terminal unit 170, and the like are assembled, thereby simplifying the assembly process of the sensor module. In addition, the guide member 171 is grasped and the output terminal unit 170 is assembled, thereby facilitating the assembly process as well as enhancing precision of the assembly process.

This embodiment describes that the blocking portion 191 is configured to selectively block the second connection path 115, however, the blocking portion 191 may selectively block the first connection path 113. Further, this embodiment describes that the first and second mounting portions 123, 125 are respectively formed at the first and second nozzle portions 112, 114. However, the mounting portion may be formed only at either the first nozzle portion 112 or the second nozzle portion 114.

Meanwhile, this embodiment describes that the connection paths 11 3, 115 are formed inside the housing 110, and the overpressure protection member 190 is installed at the connection paths 113,115. However, the sensor 130 may be connected to the channel via a tube-type connection path without the housing 110, and the overpressure protection member may be installed to the tube-type connection path.

FIG. 10 is a perspective view showing an overpressure protection means according to another embodiment of the present invention.

Referring to FIG. 10, the overpressure protection member 290 according to this embodiment may include a blocking portion 291 and a support portion 292. The support portion 292 may include a ring-type fixed portion 293 and an elastic portion 295. Such configuration is the same as the previous embodiments.

However, the elastic portion 295 according to this embodiment may include a first elastic portion 295a and a second elastic portion 295b. The blocking portion 291, the first elastic portion 295a and the second elastic portion 295b are respectively disposed at a hollow portion 294 of the fixed portion 293.

One end of the first elastic portion 295a is connected to the fixed portion 293, and another end of the first elastic portion 295a is connected to the blocking portion 291. The first elastic portion 295a is disposed to surround one side of the blocking portion 291.

One end of the second elastic portion 295b is connected to the fixed portion 293, and another end of the second elastic portion 295b is connected to the blocking portion 291. The second elastic portion 295b is disposed to surround another side of the blocking portion 291.

One end of the first elastic portion 295a and one end of the second elastic portion 295b are connected to the fixed portion 293 with a separated state therebetween by approximately 180°.

That is, one end of the first elastic portion 295a and one end of the second elastic portion 295b are connected to the fixed portion 293 so as to be spaced from each other at approximately 180° centering around a center line CL of the fixed portion 293.

In addition, another end of the first elastic portion 295a and another end of the second elastic portion 295b are connected to the blocking portion 291 at a position where they are spaced from each other at approximately 180°.

Accordingly, the center line CL of the blocking portion 291 is aligned to the movement direction of the fluid on the connection paths 113, 115 (referring to FIG. 3a). Thus, the blocking portion 291 can perform a linear-reciprocating motion along the movement direction of the fluid on the connection paths 113, 115. Thus, the blocking portion 291 may effectively block the connection paths 113, 115.

FIG. 11 is a cross-sectional view showing the sensor module according to another embodiment of the present invention.

Referring to FIG. 11, the sensor module according to this embodiment has the same configuration as the sensor module according to the previous embodiment, except that a sealing ring 340 is inserted between a cover 321 and a second nozzle portion 314.

The sealing ring 340 is disposed between an upper surface 327b of a cover stepped portion 327 and an upper surface 316b of a nozzle stepped portion 316. As the sealing ring 340 is disposed in such configuration, inside the housing 310 can be in a sealed state, mainly by the coupling of a lower surface 327a of the cover stepped portion 327 and a lower surface 316a of the nozzle stepped portion 316, and additionally by the sealing ring 340. Here, the sealing ring 340 may be formed of a rubber material having elasticity.

FIG. 12 is a conceptual view showing an air conditioner as an exemplary fluid circulation system to which the sensor module according to the present invention is applied.

Referring to FIG. 12, the air conditioner includes an outdoor unit 410 installed outdoors, an indoor unit 420 installed indoors, and a microcomputer 430.

The outdoor unit 410 may include a compressor 413 as a driving source, an outdoor heat exchanger 414, an outdoor fan 415, an expansion valve 416, a sensor module 411, an accumulator 412, etc. which are sequentially installed on a channel And, the indoor unit 420 may include an indoor heat exchanger 421 and an indoor fan 422.

A refrigerant, which is a fluid flowing along a channel 460, is compressed by the compressor 413 and then moved to the outdoor heat exchanger 414 in a gas state of high temperature/high pressure. And, the thusly moved fluid exchanges heat with the outdoor air.

The outdoor fan 415 is configured to forcibly blow the outdoor air to the outdoor heat exchanger 414, thereby enhancing heat exchange efficiency of the outdoor heat exchanger 414. The fluid having exchanged heat with the outdoor air in the outdoor heat exchanger 414 is condensed, thus to be in a liquid state of high temperature/high pressure. The fluid having passed the outdoor heat exchanger 414 is rapidly expanded into a liquid state of low temperature/low pressure, while passing the expansion valve 416.

The refrigerant expanded in the liquid state is transformed its phase into a gas state while passing the indoor heat exchanger 421. Here, the refrigerant absorbs indoor heat through the indoor heat exchanger 421. And, the indoor fan 422 forcibly blows indoor air to the indoor heat exchanger 421, thereby enhancing heat exchange efficiency of the indoor heat exchanger 421.

The refrigerant, having passed the indoor heat exchanger 421, is introduced to the sensor module 411. The sensor module 411 detects a pressure or temperature of the refrigerant, and outputs the detected information as electrical signals. The outputted electrical signals are transmitted to the microcomputer 430. Then, the microcomputer 430 compares the transmitted electrical signals with a reference profile, and yields a pressure or temperature of the fluid. Based on the yielded pressure or temperature, the microcomputer 430 controls the compressor 413, thereby controlling the pressure or flux of the refrigerant.

The refrigerant having passed the sensor module 411 is introduced into the accumulator 412. The accumulator 412 is configured to perform a separation of the refrigerant in the liquid state, moisture absorption or anti-freezing function of an evaporator, or the like. The refrigerant, having passed the accumulator 412, is introduced back into the compressor 413, and then repetitively flows on the channel by the above-described cycle.

As so far described, the indoor air is cooled by the circulating refrigerant. In this embodiment, the liquid circulation cycle for cooling is described, however, if the cycle is performed backward, the cycle can be used for a heater.

In this embodiment, the cooler or heater is described. In addition to the cooler or heater, however, this invention can be applied to all fluid circulation systems which need to detect physical information (e.g., temperature or pressure of a circulating fluid), or chemical information (e.g., elements of a fluid).

As above-mentioned, the present invention installs the overpressure protection means to the connection paths connecting the sensor and the channel, thereby preventing the transfer of the overpressure to the sensor, thus to prevent the damage of the sensor due to the overpressure.

In addition, the present invention may simplify the overpressure protection means and the installation structure thereof, by physically moving the blocking portion of the overpressure protection means by elasticity of the elastic portion. After the temporary overpressure is released, the sensor can be normally operated, thereby operating the fluid circulation system more efficiently.

Further, the present invention simplifies the structure of the sensor module, thereby simplifying and facilitating the assembly process of the sensor module. In addition, the number of the components is reduced, thereby reducing the manufacturing cost of the sensor module.

Further, the present invention may increase the application scope of the sensor by the interface circuit, which converts the electrical signals of the physical or chemical information of the fluid outputted from the sensor into the reference profile of the microcomputer.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A sensor module, comprising:
a housing having a connection path connected to a channel on which a fluid flows;
a sensor disposed inside the housing so as to be communicated with the connection path, and measuring information about the fluid introduced from the connection path; and
an overpressure protection means disposed at the connection path, and selectively blocking the connection path according to a pressure applied from the fluid so as to prevent the transfer of a pressure greater than a reference pressure to the sensor.

2. The sensor module of claim 1, wherein the overpressure protection means comprises:
a fixed portion fixed to the connection path;
a blocking portion selectively blocking the connection path by movement; and
an elastic portion connecting the fixed portion and the blocking portion, and elastically deformed according to an intensity of the pressure transferred to the blocking portion so as to enable the blocking portion to selectively block the connection path.

3. The sensor module of claim 2, wherein a hollow portion is formed in the fixed portion so as to flow the fluid therein, and the blocking portion is disposed on the hollow portion and is formed in a shape corresponding to the connection path.

4. The sensor module of claim 2, wherein the elastic portion is connected to the fixed portion by being extended from one side of the blocking portion.

5. The sensor module of claim 2, wherein the elastic portion comprises:
a first elastic portion having one end thereof connected to the fixed portion and having another end thereof connected to the blocking portion so as to surround one side of the blocking portion; and
a second elastic portion having one end thereof connected to the fixed portion and having another end thereof connected to the blocking portion so as to surround another side of the blocking portion,
wherein each one end of the first and second elastic portions is respectively connected to the fixed portion with a separated state therebetween by 180° centering around a center line perpendicular to the blocking portion.

6. The sensor module of claim 2, wherein the housing comprises a nozzle unit having the connection path, and a cover hermetically coupled to the nozzle unit, and
wherein the nozzle unit comprises a first nozzle portion connected to the channel, and a second nozzle portion coupled to the first nozzle portion and the cover.

7. The sensor module of claim 6, wherein a nozzle stepped portion and a cover stepped portion hermetically coupled to the nozzle stepped portion are respectively formed at the second nozzle portion and the cover, and a sealing ring is inserted between the second nozzle portion and the cover.

8. The sensor module of claim 6, wherein the connection path includes a first connection path disposed at the first nozzle portion to be communicated with the channel, and a second connection path disposed at the second nozzle portion to be communicated with the first connection path.

9. The sensor module of claim 8, wherein at least one of the first and second nozzle portions is provided with a mounting unit extending from at least one of the first and second connection paths so as to mount the overpressure protection means thereon.

10. The sensor module of claim 9, wherein the mounting unit comprises:
a first mounting portion extending from the first connection path on a surface facing the second nozzle portion of the first nozzle portion; and
a second mounting portion extending from the second connection path so as to correspond to the first mounting portion on a surface facing the first nozzle portion of the second nozzle portion,
wherein at least one of the first and second mounting portions is provided with a fixing hole for fixing the overpressure protection member.

11. The sensor module of claim 8, further comprising:
an interface board electrically connected to the sensor, and having an interface circuit for processing an electrical signal outputted from the sensor patterned thereon,
wherein the interface board is disposed between the sensor and the second nozzle portion.

12. The sensor module of claim 11, wherein the sensor is provided with a third connection path, which is communicated with the second connection path and for guiding the fluid introduced via the first and second connection paths to the sensor, and a slit for inserting the third connection path therein is formed on the interface board.

13. The sensor module of claim 11, wherein the sensor is provided with at least one sensor output pin for outputting the electrical signal from the sensor, and a sensor connection hole for inserting the sensor output pin thereinto is formed on the interface board so as to be electrically connected to the interface circuit.

14. The sensor module of claim 11, further comprising:
an output terminal unit electrically connected to the interface board so as to output the electrical signal transmitted from the interface board to the outside,
wherein the output terminal unit comprises:
a plurality of output lines having one end thereof electrically connected to the interface board, and having another end thereof exposed to the outside of the housing; and
a guide member for fixing the plurality of output lines.

15. The sensor module of claim 14, wherein the cover is provided with a connector unit having a plurality of exposing holes therethrough which another ends of the plurality of output lines are exposed outside by being inserted, and
wherein a connector receiving groove is formed at the connector unit so as to receive a connector which is electrically connected to another end of the plurality of output lines.

16. A sensor module, comprising:
a sensor for detecting information about a fluid flowing along a channel;
a connection path for communicating the channel with the sensor so as to introduce the fluid flowing along the channel into the sensor; and
an overpressure protection member for selectively blocking the connection path according to an intensity of a pressure applied from the fluid so as to prevent the transfer of a pressure greater than a reference pressure to the sensor.

17. The sensor module of claim 16, further comprising:
an interface circuit electrically connected to the sensor, and for converting the electrical signal outputted from the sensor so as to correspond to a reference profile.

18. A fluid circulation system, comprising:
a driving source;
a channel on which a fluid driven by the driving source flows; and
a sensor module connected to the channel so as to detect information about the fluid,
wherein the sensor module comprises:
a housing having a connection path communicated with the channel on which the fluid flows;
a sensor disposed inside the housing so as to measure information about the fluid introduced via the connection path; and
an overpressure protection member for selectively blocking the connection path according to a pressure applied from the fluid so as to prevent the transfer of a pressure greater than a reference pressure to the sensor.

19. The fluid circulation system of claim 18, further comprising:
a microcomputer for controlling the driving source based on the information about the fluid detected by the sensor module;
wherein the sensor module comprises:
a sensor for detecting the fluid information and outputting the detected information as a primary electrical signal; and
an interface circuit for converting the primary electrical signal into a secondary electrical signal so as to correspond to a reference profile stored in the microcomputer.

20. The fluid circulation system of claim 18, wherein the driving source comprises a compressor for compressing the fluid by a driving force,
wherein the system is further comprised:
an outdoor heat exchanger disposed on the channel for condensing a fluid of high temperature/high pressure compressed by the compressor;
an expansion valve disposed on the channel for expanding the fluid condensed by the outdoor heat exchanger into a fluid of low temperature/low pressure; and
an indoor heat exchanger disposed on the channel for exchanging the fluid having passed the expansion valve with an indoor air, and
wherein the sensor module is disposed between the indoor heat exchanger and the compressor.

21. A fluid circulation system, comprising:
a channel on which a fluid is circulated;
a sensor disposed on the channel to detect fluid information;
a connection path for connecting the channel and the sensor so as to flow the fluid therebetween; and
an overpressure protection member for selectively blocking the connection path according to a pressure applied from the fluid so as to prevent the transfer of a pressure greater than a reference pressure of the fluid to the sensor.

22. A method for assembling a sensor module, comprising:
mounting an overpressure protection member for selectively blocking a connection path according to a pressure applied from a channel, to a nozzle portion having the connection path connected to the channel so as to be communicated therewith;
installing, to the nozzle portion, a sensor for detecting fluid information;
mounting, to the sensor, an interface board for processing an electrical signal outputted from the sensor;
installing, on the interface board, an output terminal unit for transferring the electrical signal to the outside; and
coupling, to the nozzle portion, a cover for hermetically covering the sensor and the interface board from the outside.

23. The method of claim 22, wherein the connection path is provided with a first connection path communicated with the channel, and a second connection path communicated with the first connection path,
wherein the sensor is provided with a third connection path communicated with the second connection path, and
wherein the sensor is installed at the nozzle portion by inserting the third connection path into the second connection path.

24. The method of claim 23, wherein the interface board is mounted to the sensor by moving in a direction perpendicular to a lengthwise direction of the third connection path so as to insert the third connection path into a slit thereof, and by moving in a lengthwise direction of the third connection path so as to insert an output pin on the sensor into a sensor connection hole thereof.

25. The method of claim 24, wherein a terminal connection hole is formed on the interface board, and the output terminal unit is mounted on the interface board as one end thereof is inserted into the terminal connection hole.
